(19) United States
(12) Patent Application Publication
(10) Pub. No.: US 2023/0093918 A1
(43) Pub. Date: Mar. 30, 2023

(54) Vehicle Theft Alarm Assembly

(71) Applicant: Luz Romero, Skokie, IL (US)

(72) Inventor: Luz Romero, Skokie, IL (US)

(21) Appl. No.: 17/487,675

(22) Filed: Sep. 28, 2021

(51) Int. Cl. B60R 25/102; B60R 25/104; B60R 25/24; G07C 9/00; H04W 4/40

(52) U.S. Cl. CPC B60R 25/102; B60R 25/104; B60R 25/243; G07C 9/00309; H04W 4/40; B60R 2325/205; G07C 2009/00769; G07C 2009/00984

(57) ABSTRACT

A vehicle theft alarm assembly includes a vehicle theft alarm that is integrated into a vehicle to sense impact on the vehicle. A key fob is provided that can be carried by a user and the key fob is in wireless communication with the vehicle theft alarm. The key fob emits an alert when the vehicle theft alarm is turned on to alert the user when the user is not close enough to the vehicle to hear the vehicle theft alarm. A personal electronic device is provided that can be employed by the user and the personal electronic device is in wireless communication with the vehicle theft alarm. The personal electronic device produces an alert when the vehicle theft alarm is turned on. In this way the personal electronic device can alert the user when the user is not close enough to the vehicle to hear the vehicle theft alarm.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to theft alarm devices and more particularly pertains to a new theft alarm device for remotely alerting a user when their vehicle theft alarm is activated. The device includes a transmitter that is integrated into a vehicle theft alarm and a key fob that is in remote communication with the transmitter. The key fob emits an audible alert and the key fob vibrates when the vehicle theft alarm is turned on. Additionally, a personal electronic device is included that is in remote communication with the transmitter. In this way the personal electronic device performs an alert subroutine when the vehicle theft alarm is turned on.

### (2) Description of Related Art Including Information Disclosed Under 37 CFR 1.97 and 1.98

The prior art relates to theft alarm devices including a vehicle theft alarm that is in communication with a global positioning system for communicating the physical location of a vehicle to a personal electronic device. The prior art discloses a rechargeable ignition key that is charged when the ignition key is inserted into an ignition. The prior art discloses a variety of theft alarm devices that each includes a key fob that is in remote communication with a vehicle theft alarm.

### (h) BRIEF SUMMARY OF THE INVENTION

An embodiment of the disclosure meets the needs presented above by generally comprising a vehicle theft alarm that is integrated into a vehicle to sense impact on the vehicle. A key fob is provided that can be carried by a user and the key fob is in wireless communication with the vehicle theft alarm. The key fob emits an alert when the vehicle theft alarm is turned on to alert the user when the user is not close enough to the vehicle to hear the vehicle theft alarm. A personal electronic device is provided that can be employed by the user and the personal electronic device is in wireless communication with the vehicle theft alarm. The personal electronic device produces an alert when the vehicle theft alarm is turned on. In this way the personal electronic device can alert the user when the user is not close enough to the vehicle to hear the vehicle theft alarm.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a vehicle theft alarm assembly according to an embodiment of the disclosure.

FIG. 2 is a perspective in-use view of an embodiment of the disclosure.

FIG. 3 is a schematic view of an embodiment of the disclosure.

### (j) DETAILED DESCRIPTION OF THE INVENTION

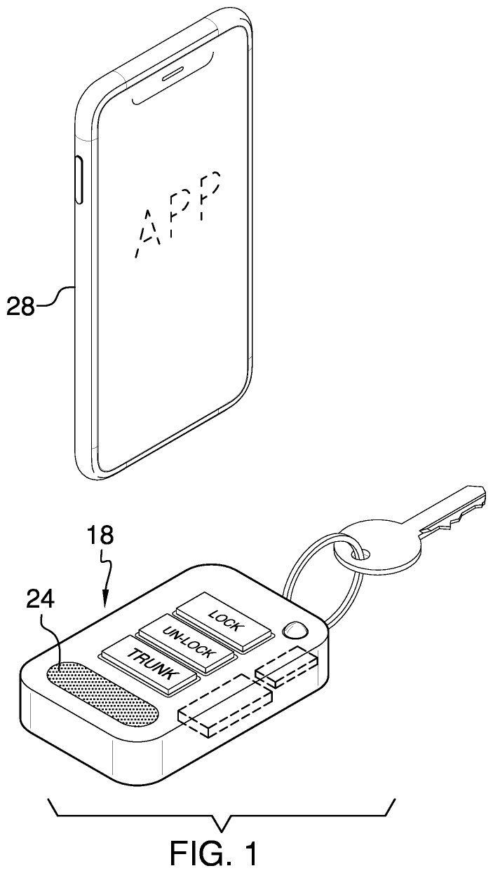

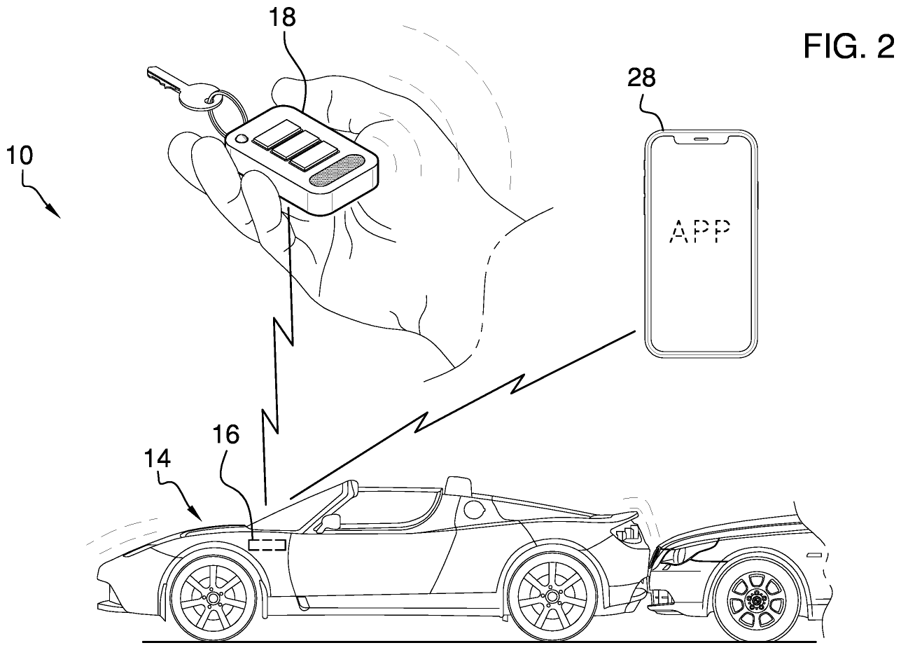

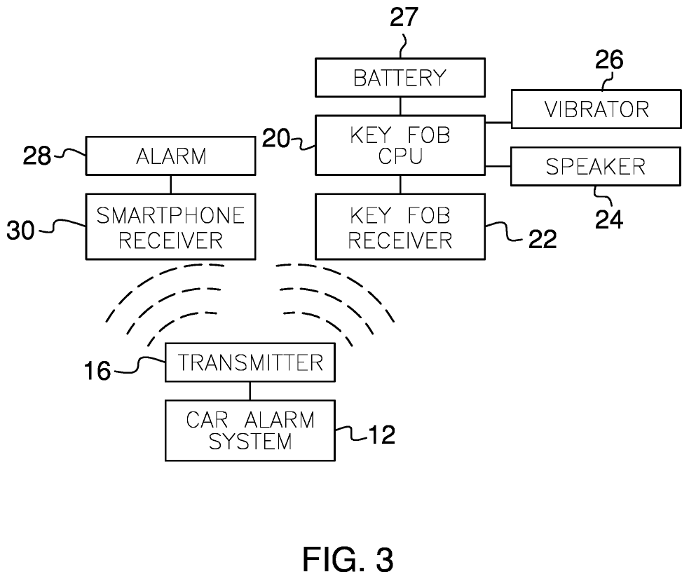

With reference now to the drawings, and in particular to FIGS. 1 through 3 thereof, a new theft alarm device embodying the principles and concepts of an embodiment of the disclosure and generally designated by the reference numeral 10 will be described.

As best illustrated in FIGS. 1 through 3, the vehicle theft alarm assembly 10 generally comprises a vehicle theft alarm 12 that is integrated into a vehicle 14 such that the vehicle theft alarm 12 can sense impact on the vehicle 14. The vehicle theft alarm 12 emits an audible alert when the vehicle theft alarm 12 is turned on. The vehicle 14 may be a passenger vehicle, a cargo vehicle or any other type of motorized vehicle that is driven on public roadways. Additionally, the vehicle theft alarm 12 may be an electronic theft alarm of any conventional design, including factory installed alarms and aftermarket alarms. A transmitter 16 is integrated into the vehicle theft alarm 12 and the transmitter 16 broadcasts an alert signal when the vehicle theft alarm 12 is turned on. The transmitter 16 may comprise a radio frequency transmitter or the like.

A key fob 18 is provided which can be carried by a user and the key fob 18 is in wireless communication with the vehicle theft alarm 12. The key fob 18 emits an alert when the vehicle theft alarm 12 is turned on. In this way the key fob 18 can alert the user when the user is not close enough to the vehicle 14 to hear the vehicle theft alarm 12. The key fob 18 includes a fob control circuit 20 that is integrated into the key fob 18 and the fob control circuit 20 receives an alert input.

A receiver 22 is integrated into the key fob 18 and the receiver 22 is electrically coupled to the fob control circuit 20. The receiver 22 is in wireless communication with the transmitter 16 and the receiver 22 receives the alert signal from the transmitter 16. The fob control circuit 20 receives the alert input when the receiver 22 receives the alert signal. Additionally, the receiver 22 may comprise a radio frequency receiver 22 or the like and the receiver 22 may operate on a frequency that is assigned to the transmitter 16 such that the receiver 22 communicates only with the transmitter 16 in the vehicle 14.

A speaker 24 is integrated into the key fob 18 to emit audible sounds from the key fob 18 and the speaker 24 is electrically coupled to the fob control circuit 20. The speaker 24 is turned on when the fob control circuit 20 receives the alert input to audibly alert the user that the vehicle 14 alarm has been turned on. A vibration unit 26 is integrated into the key fob 18 and the vibration unit 26 is in physical contact with the key fob 18 such that the vibration unit 26 vibrates the key fob 18 when the vibration unit 26 is turned on. In this way the vibration unit 26 can physically alert the user that the vehicle 14 alarm has been turned on. The key fob 18 includes at least one battery 27 that is electrically coupled to the fob control circuit 20.

A personal electronic device 28 is provided and the personal electronic device 28 can be employed by the user. The personal electronic device 28 is in wireless communication with the vehicle theft alarm 12 via smart phone receiver 30. Furthermore, the personal electronic device 28 produces an alert when the vehicle theft alarm 12 is turned on. In this way the personal electronic device 28 can alert the user when the user is not close enough to the vehicle 14 to hear the vehicle theft alarm 12. The personal electronic device 28 has wireless communication capabilities and the personal electronic device 28 is in wireless communication with the transmitter 16. The personal electronic device 28 performs an alert subroutine when the personal electronic device 28 receives the alert signal from the transmitter 16. The personal electronic device 28 may comprise a smart phone or other type of electronic device that has wireless communication capabilities. Additionally, the alert subroutine may be included in a smart phone application or other type of program that is stored in the smart phone.

In use, the key fob 18 emits the audible alert and the key fob 18 vibrates when the vehicle theft alarm 12 is turned on. Additionally, the personal electronic device 28 produces the alert when the vehicle theft alarm 12 is turned on. In this way the user is alerted when the user is too far from the vehicle 14 to hear the vehicle theft alarm 12. Furthermore, the key fob 18 and the personal electronic device 28 facilitate the user to differentiate between the vehicle theft alarm 12 in their vehicle 14 and the vehicle theft alarm 12 in a vehicle 14 that is not theirs. Thus, the user can chose to ignore vehicle theft alarm 12s in an urban environment that might have the same audible tone as the vehicle theft alarm 12 in their vehicle 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle theft alarm assembly for remotely alerting a user of potential theft of a vehicle of the user, said assembly comprising:
a vehicle theft alarm being integrated into a vehicle wherein said vehicle theft alarm is configured to sense impact on the vehicle, said vehicle theft alarm emitting an audible alert when said vehicle theft alarm is turned on;
a key fob being configured to be carried by a user, said key fob being in wireless communication with said vehicle theft alarm, said key fob emitting an alert when said vehicle theft alarm is turned on wherein said key fob is configured to alert the user when the user is not close enough to the vehicle to hear said vehicle theft alarm; and
a personal electronic device being configured to be employed by the user, said personal electronic device being in wireless communication with said vehicle theft alarm, said personal electronic device producing an alert when said vehicle theft alarm is turned on wherein said personal electronic device is configured to alert the user when the user is not close enough to the vehicle to hear said vehicle theft alarm.

2. The assembly according to claim 1, wherein:
said assembly includes a transmitter being integrated into said vehicle theft alarm, said transmitter broadcasting an alert signal when said vehicle theft alarm is turned on;
said key fob includes:
a fob control circuit being integrated into said key fob, said fob control circuit receiving an alert input; and
a receiver being integrated into said key fob, said receiver being electrically coupled to said fob control circuit, said receiver being in wireless communication with said transmitter, said receiver receiving said alert signal from said transmitter, said fob control circuit receiving said alert input when said receiver receives said alert signal.

3. The assembly according to claim 2, wherein said key fob includes:
a speaker being integrated into said key fob wherein said speaker is configured to emit audible sounds from said key fob, said speaker being electrically coupled to said fob control circuit, said speaker being turned on when said fob control circuit receives said alert input wherein said speaker is configured to audibly alert the user that said vehicle alarm has been turned on; and
a vibration unit being integrated into said key fob, said vibration unit being in physical contact with said key fob such that said vibration unit vibrates said key fob when said vibration unit is turned on wherein said vibration unit is configured to physically alert the user that said vehicle alarm has been turned on.

4. The assembly according to claim 1, wherein:
said assembly includes a transmitter being integrated into said vehicle theft alarm, said transmitter broadcasting an alert signal when said vehicle theft alarm is turned on; and
said personal electronic device has wireless communication capabilities, said personal electronic device being in wireless communication with said transmitter, said personal electronic device performing an alert subroutine when said personal electronic device receives said alert signal from said transmitter.

5. A vehicle theft alarm assembly for remotely alerting a user of potential theft of a vehicle of the user, said assembly comprising:
a vehicle theft alarm being integrated into a vehicle wherein said vehicle theft alarm is configured to sense impact on the vehicle, said vehicle theft alarm emitting an audible alert when said vehicle theft alarm is turned on;
a transmitter being integrated into said vehicle theft alarm, said transmitter broadcasting an alert signal when said vehicle theft alarm is turned on;
a key fob being configured to be carried by a user, said key fob being in wireless communication with said vehicle theft alarm, said key fob emitting an alert when said vehicle theft alarm is turned on wherein said key fob is configured to alert the user when the user is not close enough to the vehicle to hear said vehicle theft alarm, said key fob including;
a fob control circuit being integrated into said key fob, said fob control circuit receiving an alert input;
a receiver being integrated into said key fob, said receiver being electrically coupled to said fob control circuit, said receiver being in wireless communication with said transmitter, said receiver receiving said alert signal from said transmitter, said fob control circuit receiving said alert input when said receiver receives said alert signal;
a speaker being integrated into said key fob wherein said speaker is configured to emit audible sounds from said key fob, said speaker being electrically coupled to said fob control circuit, said speaker being turned on when said fob control circuit receives said alert input wherein said speaker is configured to audibly alert the user that said vehicle alarm has been turned on;
a vibration unit being integrated into said key fob, said vibration unit being in physical contact with said key fob such that said vibration unit vibrates said key fob when said vibration unit is turned on wherein said vibration unit is configured to physically alert the user that said vehicle alarm has been turned on; and
a personal electronic device being configured to be employed by the user, said personal electronic device being in wireless communication with said vehicle theft alarm, said personal electronic device producing an alert when said vehicle theft alarm is turned on wherein said personal electronic device is configured to alert the user when the user is not close enough to the vehicle to hear said vehicle theft alarm, said personal electronic device having wireless communication capabilities, said personal electronic device being in wireless communication with said transmitter, said personal electronic device performing an alert subroutine when said personal electronic device receives said alert signal from said transmitter.

6. A vehicle theft alarm system for remotely alerting a user of potential theft of a vehicle of the user, said assembly comprising:
a vehicle;
a vehicle theft alarm being integrated into said vehicle wherein said vehicle theft alarm is configured to sense impact on said vehicle, said vehicle theft alarm emitting an audible alert when said vehicle theft alarm is turned on;
a transmitter being integrated into said vehicle theft alarm, said transmitter broadcasting an alert signal when said vehicle theft alarm is turned on;
a key fob being configured to be carried by a user, said key fob being in wireless communication with said vehicle theft alarm, said key fob emitting an alert when said vehicle theft alarm is turned on wherein said key fob is configured to alert the user when the user is not close enough to said vehicle to hear said vehicle theft alarm, said key fob including:
a fob control circuit being integrated into said key fob, said fob control circuit receiving an alert input;
a receiver being integrated into said key fob, said receiver being electrically coupled to said fob control circuit, said receiver being in wireless communication with said transmitter, said receiver receiving said alert signal from said transmitter, said fob control circuit receiving said alert input when said receiver receives said alert signal;
a speaker being integrated into said key fob wherein said speaker is configured to emit audible sounds from said key fob, said speaker being electrically coupled to said fob control circuit, said speaker being turned on when said fob control circuit receives said alert input wherein said speaker is configured to audibly alert the user that said vehicle alarm has been turned on;
a vibration unit being integrated into said key fob, said vibration unit being in physical contact with said key fob such that said vibration unit vibrates said key fob when said vibration unit is turned on wherein said vibration unit is configured to physically alert the user that said vehicle alarm has been turned on; and
a personal electronic device being configured to be employed by the user, said personal electronic device being in wireless communication with said vehicle theft alarm, said personal electronic device producing an alert when said vehicle theft alarm is turned on wherein said personal electronic device is configured to alert the user when the user is not close enough to said vehicle to hear said vehicle theft alarm, said personal electronic device having wireless communication capabilities, said personal electronic device being in wireless communication with said transmitter, said personal electronic device performing an alert subroutine when said personal electronic device receives said alert signal from said transmitter.
